(19) United States
(12) Patent Application Publication
(10) Pub. No.: US 2026/0280211 A1
(43) Pub. Date: Sep. 17, 2026

(54) BRUSH MODULE FOR SUPPLYING CURRENT TO A ROTOR OF AN ELECTRIC DRIVE MACHINE OF A MOTOR VEHICLE

(71) Applicant: Schaeffler Technologies AG & Co. KG, Herzogenaurach (DE)

(72) Inventor: Stefan Dupke, Neuenmarkt (DE)

(73) Assignee: Schaeffler Technologies AG & Co. KG, Herzogenaurach (DE)

(21) Appl. No.: 19/473,582

(22) PCT Filed: Feb. 8, 2024
(86) PCT No.: PCT/DE2024/100187

§ 371 Date: Oct. 8, 2025

(30) Foreign Application Priority Data
Apr. 11, 2023 (DE) 10 2023 109 026.7

(51) Int. Cl. H01R 39/26; H01R 39/39; H02K 13/10

(52) U.S. Cl. CPC H01R 39/26; H01R 39/39; H02K 13/10

(57) ABSTRACT

The disclosure relates to a brush module for supplying current to a rotor of an electric drive machine of a motor vehicle. The brush module includes a heat-dissipating metal support core, on each of the base surfaces of which a separate electrically insulating intermediate plate and, on each intermediate plate, a separate electrically conductive brush support plate having at least one brush pocket is stacked. A plurality of fingers protrude integrally from an exposed outer edge of the metal support core to allow the brush module to be fixedly attached to project integrally from a metal support core-side top surface of each intermediate plate and terminate at the end in openings in the other intermediate plate. A partial stack is formed by the overlapping elements of the brush support plate, intermediate plate, metal support core and intermediate plate.

### CROSS-REFERENCE TO RELATED APPLICATIONS

This application is the U.S. National Phase of PCT Application No. PCT/DE2024/100187 filed on Mar. 8, 2024, which claims priority to DE 10 2023 109 026.7 filed on Apr. 11, 2023, the entire disclosures of which are incorporated by reference herein.

### TECHNICAL FIELD

The disclosure relates to a brush module for supplying current to a rotor of an electric drive machine of a motor vehicle.

### BACKGROUND

DE 10 2019 100 729 B4 discloses a brush module, on the brush support plates of which a plurality of brush pockets are applied for housing the respective current-carrying brushes. The heat-dissipating metal core (keyword: passive cooling) is molded in plastic, except for parts around its connection means and along its outer edge.

### SUMMARY

The object is to create a cost-effective and simply constructed brush module.

According to the disclosure, this object is achieved in that there is a separate electrically insulating intermediate plate as an intermediate layer on each base surface of the metal support core and the brush support plates each run on said intermediate plate. An outer edge of the metal support core is exposed and a plurality of fingers protrude integrally from this as means of connecting the brush module to the surrounding structure. A plurality of axial pins, which are guided through respective openings in the metal support core and each have a blind hole, project integrally from a metal support core-side top surface of each intermediate plate and terminate at the end in openings in the other intermediate plate. When viewed from either a top side and a bottom side of the brush module, in each case a partial stack is formed by the four overlapping elements of the brush support plate, intermediate plate, metal support core, and intermediate plate. The partial stack is joined together using connecting means that project from an outer side of each brush support plate, extend through openings in the brush support plate, and end in the blind holes in the axial pins.

This creates a brush module with a simple modular structure, the components of which are easy to manufacture and assemble, and which ultimately consists of a stack of five modules divided into two sub-stacks of four. The two pole sides (top and bottom side) of the module are also excellently electrically insulated. Via its integrally connected fingers, the central and laterally exposed metal support core allows for good dissipation of the heat energy generated during contact between the brushes of the brush module and a slip ring system of the rotor of the electric drive machine to the surrounding structure, which surrounding structure is usually a housing of the electric drive machine.

A special feature here is the axial pins extending from each electrically insulating intermediate plate through openings (such as bores) in the metal support core and integrally connected to the intermediate plate, which end in openings (such as bores) in the further intermediate plate located behind the metal support core and, according to a development of the disclosure, alternately and oppositely penetrate the metal support core.

Screws, pins, rivets or the like can be used as connection means for displaying the respective sub-stack of 4, comprising the brush support plate, the intermediate plate, the metal support core, and the intermediate plate, which, starting from the outer side of the respective brush support plate, are joined through openings (such as bores) in the brush support plate with the blind holes in the axial pins. In an example embodiment of screws, these extend with their heads on the brush support plates and are screwed with counter threads in the blind holes in the axial pins.

The metal support core and/or the two brush support plates can be made from sheet steel by stamping and bending, wherein the brush support plates can be provided as common parts, i.e., they are identical to one another, which helps to keep manufacturing and logistics costs under control. The same applies to the two electrically insulating intermediate plates, which may also have segment-like incisions on their outer edge and through which the offset sections of the fingers of the metal support core can be guided. The segment-like incisions can also be used for the insertion of an assembly tool or handling tool.

The above-mentioned fingers of the metal support core can extend as contact plates with a comparatively wide contact surface that is flat when screwed to the surrounding structure. These fingers may be slightly curved in the unscrewed state, so that a well-tensioned flat system can be expected after screwing. Depending on the nature of the contact side of the surrounding structure (preferably the housing of the electric drive machine), the contact surfaces of the fingers may also have a geometry that deviates from the flat course.

It is indeed conceivable and intended to provide the brush support pockets of the brush support plates as separate sheet metal housings, which are subsequently joined to the brush support pockets, for example by welding, clipping, plugging, etc. However, it is more advantageous to cut the brush support pockets out of the brush support plates as tab sections.

According to a further embodiment of the disclosure, the stacked elements forming the brush module, or at least parts thereof, such as in particular the elements of the metal support core and intermediate plates, can be substantially circular disc-like. Such a design saves material and installation space and requires only comparatively simple tools.

The intermediate plates with their integral connected axial pins can be made of a material with good electrical insulation, such as plastic or mechanical engineering ceramic.

### BRIEF DESCRIPTION OF THE DRAWINGS

In the drawings:

FIG. 1 shows a spatial view of the brush module from above;

FIG. 2 shows a side view of the brush module;

FIG. 3 shows a cutaway view of the brush module;

FIG. 4 shows a spatial view of the metal support core with joined lower intermediate plate;

FIG. 5 shows the upper/lower intermediate plate as a detail; and

FIG. 6 shows a partial view of the slightly curved contact plate of a finger on the surrounding structure.

### DETAILED DESCRIPTION

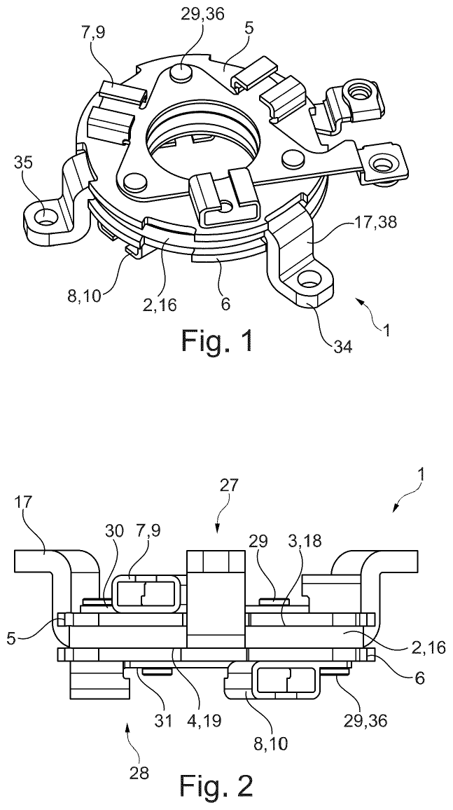

FIGS. 1-3 show a brush module 1 for supplying current to a rotor of an electric drive machine of a motor vehicle, wherein FIGS. 4-6 disclose details of the brush module 1.

The brush module 1 has a central heat-dissipating metal support core 2 made of stamped sheet steel in a circular disc-like geometry, from the exposed outer edge 16 of which three fingers 17, which are distributed uniformly around the circumference, protrude integrally. These fingers serve to provide a fixed connection of the brush module 1 to a surrounding structure 37 (housing) of the electric drive machine.

A separate electrically insulating intermediate plate 5, 6 is stacked on each base surface 3, 4 of the metal support core 2. The two intermediate plates 5, 6 in turn have a circular disc-shaped basic shape and are made of injection-molded plastic, for example.

On each of the intermediate plates 5, 6, there is a separate electrically conductive brush support plate 7, 8 with three brush pockets 9, 10. The brush support plates 7, 8 are formed from sheet steel by stamping and bending. The brush support pockets 9, 10 of the brush support plates are connected thereto integrally and consist of bent-up tab sections.

The elements of the metal support core 2, intermediate plates 5, 6, and brush support plates 7, 8 each have a hole-like recess 11, 12, 13, 14, 15 for jointly enclosing the rotor of the electric drive machine.

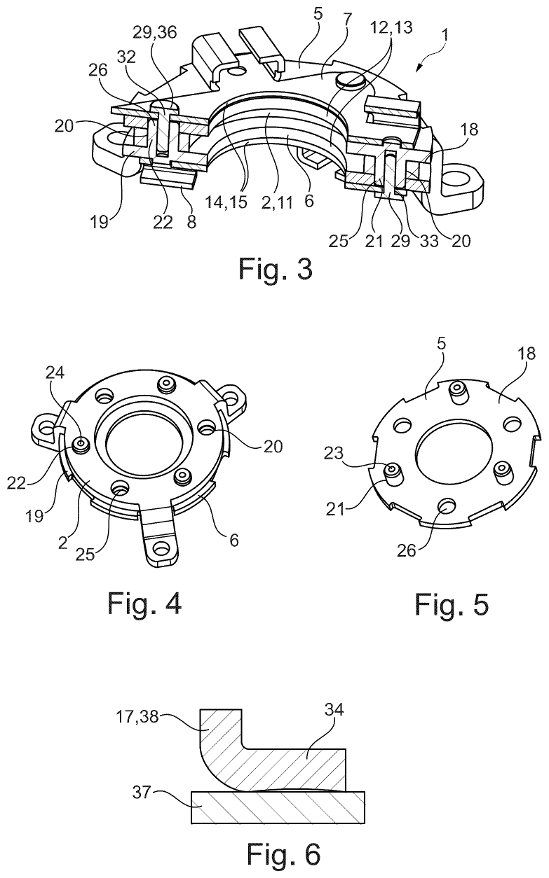

As can be seen from FIGS. 3-5, three axial pins 21, 22, which are distributed uniformly around the circumference and each have a blind hole 23, 24 therein, protrude integrally from a top surface 18, 19 on the metal support core side of each intermediate plate 5, 6. In the assembled state, the axial pins extend through respective openings 20 of the metal support core 2 and end at the end in respective openings 25, 26 of the other intermediate plate 6, 5. FIG. 5 shows the upper intermediate plate 5 still to be mounted according to FIG. 4.

As shown, the axial pins 21, 22 of the two intermediate plates 5, 6 alternately and oppositely engage one of the openings 20 of the metal support core 2.

It is noticeable that, viewed from a top side and a bottom side 27, 28 of the brush module 1, in each case a partial stack is formed by the four overlapping elements of the brush support plate 7, 8, intermediate plate 5, 6, metal support core 2, and intermediate plate 6, 5. Each partial stack is joined together or secured together by screws extending from an outer side 30, 31 of the respective brush support plate 7, 8 as connecting means 29. Each screw 29 (see FIG. 3), which rests with its head 36 on the outer side 30, 31 of the respective brush support plate 7, 8, extends through an opening 32, 33 in the brush support plate 7, 8 and is screwed with a counter thread in the blind hole 23, 24 of the respective axial pin 21, 22.

Each finger 17 of the metal support core 2 protrudes slightly from its outer edge 16 and is then continued or extended in an offset section 38 (see FIG. 1), which ends in a foot-like contact plate 34 angled therefrom for direct connection of the brush module 1 to the surrounding structure 37. Each contact plate 34 has a bore 35 for screwing to the surrounding structure 37.

As FIG. 6 shows, the respective contact plate 34 in the unscrewed state has a slightly curved shape away from the surrounding structure 37. When screwing, the contact plate 34 “sits”, which ensures good heat transfer into the surrounding structure 37.

### LIST OF REFERENCE SYMBOLS

1) Brush module
2) Metal support core
3) Base surface
4) Base surface
5) Intermediate plate
6) Intermediate plate
7) Brush support plate
8) Brush support plate
9) Brush pocket
10) Brush pocket
11) Recess
12) Recess
13) Recess
14) Recess
15) Recess
16) Outer edge
17) Finger
18) Top surface
19) Top surface
20) Opening
21) Axial pin
22) Axial pin
23) Blind hole
24) Blind hole
25) Opening
26) Opening
27) Top side
28) Bottom side
29) Connecting means, screw
30) Outer side
31) Outer side
32) Opening
33) Opening
34) Contact plate
35) Bore
36) Head
37) Surrounding structure
38) Offset section

1. A brush module for supplying current to a rotor of an electric drive machine of a motor vehicle, the brush module comprising:
a heat-dissipating metal support core having a plurality of fingers protruding integrally from an exposed outer edge of the metal support core, the plurality of fingers configured to fixedly attach the brush module to a surrounding structure,
a separate first intermediate plate disposed on a first base surface of the heat-dissipating metal support core,
a separate second intermediate plate disposed on a second base surface of the heat-dissipating metal support core, each of the first and second intermediate plates configured as electrically insulating plates,
a separate first brush support plate stacked on the first intermediate plate, and
a separate second brush support plate stacked on the second intermediate plate, and each of the first and second brush support plates: i) configured as electrically conductive plates, and ii) having at least one brush pocket, and
the metal support core, the first and second intermediate plates, and the first and second brush support plates each have a recess configured for jointly enclosing the rotor, and
a plurality of axial pins guided through respective openings in the metal support core, each one of the plurality of axial pins having a blind hole and projecting integrally from a metal support core-side top surface of one of the first and second intermediate plates and terminating in openings in a remaining one of the first and second intermediate plates, and
when viewed from either a top side or a bottom side of the brush module, in each case a partial stack is formed via overlapping elements of the first and second brush support plates, the first and second intermediate plates, and the metal support core, which partial stack is joined via connecting means that project from an outer side of each of the first and second brush support plates, extend through openings in the first and second brush support plates, and end in blind holes in the plurality of axial pins.

2. The brush module according to claim 1, wherein screws are provided as the connecting means, and one of the screws is screwed with a counter thread in the blind hole of a respective axial pin and lies with its head on an outer side of a respective one of the first and second brush support plates.

3. The brush module according to claim 1, wherein the metal support core comprises stamped sheet steel and the plurality of fingers extend into offset sections which sweep over the top or bottom side of the brush module (1), and the offset sections end in contact plates angled therefrom, the contact plates configured for direct connection of the brush module to the surrounding structure.

4. The brush module according to claim 3, wherein the contact plates have integral bores configured for screwing to the surrounding structure and in an unscrewed state, the contact plates have a curved shape away from the surrounding structure.

5. The brush module according to claim 1, wherein the plurality of axial pins of the first and second intermediate plates alternately and oppositely engage one of the openings of the metal support core.

6. The brush module according to claim 1, wherein the first and second brush support plates are formed from sheet steel via stamping and bending, and the brush pockets thereof comprise tab sections which are integrally connected to the first and second brush support plates and also separated therefrom and bent up.

7. The brush module according to claim 1, wherein the metal support core, the first and second intermediate plates, and the first and second brush support plates are substantially disc-shaped.

8. The brush module according to claim 1, wherein the first and second brush support plates are provided as identical parts.

9. The brush module according to claim 1, wherein the first and second intermediate plates (5, 6) are constructed of plastic.

10. The brush module according to claim 1, wherein the first and second intermediate plates or the first and second brush support plates are substantially circular.

11. The brush module according to claim 1, wherein the first and second intermediate plates are provided as identical parts.

12. A brush module for supplying current to a rotor of an electric drive machine of a motor vehicle, the brush module comprising:
a heat-dissipating metal support core having a plurality of fingers protruding integrally from an exposed outer edge of the metal support core, the plurality of fingers configured to fixedly attach the brush module to a surrounding structure,
a separate first intermediate plate disposed on a first base surface of the heat-dissipating metal support core,
a separate second intermediate plate disposed on a second base surface of the metal support core, each of the first and second intermediate plates configured as electrically insulating plates
a separate first brush support plate stacked on the first intermediate plate, and
a separate second brush support plate stacked on the second intermediate plate, and each of the first and second brush support plates: i) configured as electrically conductive plates, and ii) having at least one integrally formed brush pocket, and
the metal support core, the first and second intermediate plates, and the first and second brush support plates each have a recess configured for jointly enclosing the rotor, and
a plurality of axial pins guided through respective openings in the metal support core, each one of the plurality of axial pins having a blind hole and projecting integrally from a metal support core-side top surface of one of the first and second intermediate plates and terminating in openings in a remaining one of the first and second intermediate plates.

13. The brush module according to claim 12, further comprising:
a first screw threadably engaged to a blind hole of a first one of the plurality of axial pins, and
a second screw threadably engaged to a blind hole of a second one of the plurality of axial pins, and
the first and second screws configured to secure together a partial stack formed by one of the first and second brush support plates, the first and second intermediate plates, and the metal support core.

14. The brush module according to claim 12, wherein the first and second brush support plates are formed from sheet steel via stamping and bending, and the brush pockets thereof comprise tab sections that are integrally formed with the first and second brush support plates.
